(19) United States
(12) Patent Application Publication
(10) Pub. No.: US 2009/0235507 A1
(43) Pub. Date: Sep. 24, 2009

(54) Method Of Repairing A Ballistics Barrier

(76) Inventors: Arthur Henry Cashin, Nashville, TN (US); Sheldrick Faris Hawkins, Hermitage, TN (US)

Correspondence Address: WADDEY & PATTERSON, P.C., 1600 DIVISION STREET, SUITE 500, NASHVILLE, TN, 37203, US

(21) Appl. No.: 12/188,329

(22) Filed: Aug. 8, 2008

Related U.S. Application Data
(63) Continuation-in-part of application No. 12/053,966, filed on Mar. 24, 2008.

(51) Int. Cl. B23P 19/04

(52) U.S. Cl. 29/402.08

(57) ABSTRACT

A method of repairing a ballistics barrier, the barrier comprised of a plurality of horizontally-offset, interconnected collapsible cells formed from a ballistics fabric. The method includes removing the damaged section of the barrier and replacing it with a substitute ballistics fabric section that is attached to the barrier so that the substitute section mimics the horizontally-offset, interconnected cell structure of the barrier.

### CROSS-REFERENCE TO RELATED APPLICATIONS

This application is a continuation-in-part application which claims benefit of co-pending U.S. patent application Ser. No. 12/053,966 filed Mar. 24, 2008, entitled “BALLISTICS BARRIER” which is hereby incorporated by reference.

### TECHNICAL FIELD

The present invention relates generally to methods of repairing ballistics barriers. More particularly, the present invention relates to methods of repairing ballistics barriers that are formed from ballistics fabric-based arrays, which provide a barrier that is readily portable, scalable, and possesses a structure optimized to dissipate and absorb the impact energy of a projectile or blast wave.

### BACKGROUND OF THE INVENTION

Ballistics barriers provide a means to mitigate the damage caused by ballistic assaults. The prior art is replete with barriers and structures designed to resist or repel such assaults. Although ballistics barriers have numerous personal and commercial applications, most uses occur in military applications. In such applications, the use of the barrier may vary according to theater of conflict. In an urban environment the barrier may be used to enhance or supplement an existing structure's ballistic defenses. In an environment without significant pre-existing infrastructure, the barrier may, itself, constitute the whole of the structure or building. This includes environments like a desert where it is common for military personnel to fabricate their own shelter because the barren landscape offers no natural or man-made alternatives.

However, regardless of the environment in which the ballistics barrier is used, an employable barrier must possess several key attributes: it must effectively protect persons or objects behind or within the barrier, it must be quick and easy to install and erect, it must be readily transportable through rugged or otherwise difficult to traverse terrain, and it must allow for simple and expeditious repairs.

Of particular import is the last attribute—repair. Because of the hostile environment in which ballistics barriers are utilized, it is paramount that if a barrier is damaged it can be readily repaired. Thus, not only must the barrier accommodate quick repairs but the reparative process cannot necessitate extensive tooling (as such tooling may not be at hand or may not be practicable to transport). Consider the following prior art ballistics barriers.

U.S. Pat. No. 4,822,657 issued to Simpson describes a bullet resistant panel having a rigid frame securing two exterior facing panels, preferably an aluminum or steel sheet, which bound a pair of cellulosic substrates. Adjacent one of the pair of cellulosic substrates and anchored to the frame is an impact resistant fabric such as Kevlar, and between the fabric and the other cellulosic substrate is an insulation layer. Simpson instructs that the bulk of the protection afforded by the assembly is attributable to the impact resistant fabric.

Norton, U.S. Pat. No. 4,198,454, discloses a lightweight projectile resistant composite panel for use in constructing a portal enclosure. The panel includes two metal plates forming the exterior walls, a honeycomb panel abutting one metal plate with the cell walls of the panel normal to that of the metal plate, an ablative material filling the honeycomb panel (designed to dissipate thermal energy), next to the honeycomb panel is a projectile resistant material comprised of ceramic fibers or woven fabric, and between the projectile resistant material and the other metal plate is a thermal insulating material. Because only the outer plates are metal, Norton claims the composite panel is well suited to be transported to remote locations.

Another ballistics barrier is shown and described by White in U.S. Pat. No. 6,907,811. White teaches a barrier having a bullet-resistant base unit with wheels so that the barrier may be easily moved. Removably attached to, and vertically collinear with, the base unit is a transparent bullet-resistant shield situated to allow the person or persons seeking refuge behind the shield to easily see through the shield.

Weatherwax, U.S. Pat. No. 7,159,503, describes an explosion protective shelter having a set of free standing walls without any rigid structural interconnection between them. The walls are comprised of a multitude of interlocking panels. Preferably, the vertical walls are engaged to a horizontal stabilizing platform in such a way that the walls are allowed to rotate about their engagement with the platform. Even more preferably, the tops of the walls are connected by springs and wires. As a result, if an explosive device is placed within the structure and detonates, the tops of the walls will deflect to absorb and direct the blast, as the non-rigid connection allows the walls to rotate outward about their pivot point (the engagement with the platform).

A ballistic barrier is described in Meeker, U.S. Application Publication No. 2006/0248827. Meeker provides for a barrier having two exterior panels composed of an elastomeric polymer, at least two rigid interior panels, and a quantity of earth material disposed between the interior rigid panels. Meeker instructs that as a projectile passes through the elastomeric polymer the polymer seals around the projectile and prevents fragmentation. The rigid interior panels and earth material serve to further impede, and eventually stop, the progress of the projectile.

Kramer, U.S. Application Publication No. 2007/0245933, provides a projectile resistant partition comprised of external cover plates arranged on stands. The cover plates bound internal bombardment plates which are at least partially made of plaster fiber materials, alleged to have superior strength and protection characteristics while being lighter than a comparably sized steel plate. Kramer instructs that this combination presents a projectile resistant partition.

The use of sandbags to form ballistics barriers is also well known in the prior art. Unfilled sandbags are portable and inexpensive. However, the use of sandbags to construct a ballistics barrier presents several problems. For instance, filling the sandbags is a labor-intensive process; typically one person holds the sandbag open while another person manually fills the bag. Further, time and effort must be dedicated to moving and arranging each individual sandbag to form a shelter. Lastly, sandbags lack the robustness needed to construct an effective ballistics barrier, i.e. they are easily torn or otherwise damaged.

Gabions, wire-metal frameworks, lined or wrapped with a geotextile material have been used in the past to provide shelter from ballistic assaults. These metal-wire structures provide the strength and resiliency to contain the earthen fill material while the geotextile wrapping prevents particulate fill material from escaping. Undesirably, when these barriers are struck by projectiles, the gabion(s) are prone to fragmentation—which creates dangerous shrapnel. Further, once the gabions have been structurally compromised they are difficult to repair (often requiring acetylene torches) and the bulky rigid frame defining the gabion is demanding to transport, thereby discouraging the carrying of extra gabions for use as replacements for damaged gabions.

Unfortunately, repairing barriers such as those discussed above often requires replacing bulky or heavy components. Further, such repairs routinely require extensive tooling and specialized knowledge to affect the repairs. These requirements can be difficulty to meet in any environment, let alone a combat setting. Thus, what is needed is a method of repairing a light-weight, versatile, and readily portable ballistics barrier, wherein the repair method readily permits repair in an inhospitable setting without significant tooling.

### SUMMARY OF THE INVENTION

The present invention discloses a method of repairing a ballistics barrier. Specifically, the present invention is directed at repairing a ballistics barrier comprised of ballistics fabric. Before elaborating on the present invention, a brief discussion of a ballistics fabric-based barrier, to which the method of repair is directed, is in order. A ballistics fabric-based barrier is uniquely capable of providing a collapsible, light-weight, resilient, and scalable means to thwart a ballistics assault. Such a ballistics barrier, or rapid deployment wall, has a plurality of layers each layer being defined by a collection of horizontally-offset, interconnected cells. The cells are formed from one or more sheets of ballistics fabric affixed together. Preferably the layers are formed from multiple sheets of fabric with the outermost sheets, i.e. the sheets that will form the exterior boundary of the layer, having a height greater than the interior sheets. Thus, a skirt is formed as a result of the height difference between the sheets, which spans the perimeter of the layer. When layers or units are stacked this inherently formed skirt serves to retain fill material deposited in the upper layer by preventing the fill from leaking out between the layers (as will be further discussed herein below).

The horizontally-offset cellular arrangement of the layers is created by affixing the ballistics fabric sheets together at predetermined positions to create the desired honeycomb pattern. Although the sheets can be attached in a plethora of ways (such as by adhesives, staples, pins, retaining clips, etc.), the preferred method is by sewing. Joints formed in accordance with this method have a structural integrity similar to that of the fabric itself.

The ballistics fabric sheets may be a high strength fabric, either woven or nonwoven. If woven, the present invention envisions any weave and natural or synthetic threads or yarns. If nonwoven, any nonwoven technology or polymer which meets a minimum of 100 lbs grab tensile (or grab tensile strength as determined by test method ASTM D4632) with a preferred range of above 300 lbs grab tensile (including woven materials, collectively referred to a “ballistics fabric” herein after).

Preferably, the fabric is a polypropylene-based, non-woven geotextile material. Such a material is known to be puncture and tear resistant, flexible, possess a high tensile strength, and to be stiff enough to form, and maintain, a framework without the aid of any external braces or supports, especially important for avoiding the creation of shrapnel or other flying debris. TYPAR®, manufactured by Fiberweb, Inc. is one such material. One desirable aspect of TYPAR material is that it has a high TEA (total energy absorbed) per unit weight, especially as compared to materials such as needle-punched fabrics which may have comparable tensile strengths.

However, in addition to those mentioned above, other materials are also envisioned. These materials include non-polypropylene based non-wovens, composite wovens, HDPE (high-density polyethylenes), polyethylene terephthalate, KEVLAR® material, and scrims reinforced fabrics. Advantageously, the non-rigid nature of the fabric, particularly a geotextile, permits a ballistics fabric-based barrier to stretch and conform to the topology of the surrounding environment. For instance, if a barrier is placed on or across a curved surface, e.g. a hill or valley, the barrier can conform to the surface topology to provide complete coverage. In contrast, if a barrier constructed of gabions were deployed across this same surface, the inflexible cages would not readily conform to the surface and would be susceptible to attacks concentrated on the regions of the barrier that did not intimately follow the contours of the surface. Further, the gabions, which have regions that do not follow the surface contours, would also be prone to fail or become ineffective due to particulate fill material leaking from the non-contoured regions.

Once a foundation layer has been erected, the cells are packed with a fill material. Most often the fill material will be soil, sand, and/or rocks (“ballistics impeding material”). Indeed, when the fill material is soil, plants can be encouraged to grow on and in the barrier, both for aesthetic reasons, and because the root system of plants may provide increased stablility to a multi-layer barrier. However, any fill material that will assist to dissipate the energy of a projectile or blast wave is acceptable.

Packing the cells can be expedited by utilizing a front end loader, a back hoe, a conveyor apparatus, or the like. Because the layer is a matrix of interconnected cells, and the geotextile fabric is self-supporting, large amounts of fill material may be deposited in multiple cells at once with a single effort. Additionally, a light-weight rigid framework may be employed to facilitate the filling process. Such a framework may be coextensive with the perimeter of the barrier and couple to some or all of the cells comprising the barrier's perimeter. This would allow the framework to provide tension across the plurality of cells to encourage the cells into their most exposed, i.e. open, position thereby facilitating the packing/filling process. Further, the framework may be constructed from a set of readily transportable rods or constituent members that interconnect to form the composite framework. Once a frame has been erected and attached to the barrier, the frame may be used to move a layer of the barrier into a desired position. Alternatively, the framework may be sized to hold open a single cell. Such a frame would be compact yet provide a single individual with the ability to easily transport and deploy the frame.

As briefly mentioned above, each layer of interconnected cells may also have a perimeter skirt or apron (as would be inherently formed by providing the external sheets of ballistics fabric comprising the layer with a greater height than the internal sheets). The skirt functions to effectively connect one layer to the next to provide rigidity and prevent any fill material deposited in the cells of the higher layer from escaping at the layer-to-layer junction with the lower layer. If neither layer has an integral skirt, one can be affixed to the interface between the lower and upper layers after the layers have been stacked. The skirt will extend around all or a portion of the exterior perimeter of the layers to create an overlap joint without any functional discontinuities. This process may be repeated for additional layers until a desired height is reached.

The above-described ballistics fabric-based barrier serves to protect persons from a ballistics assault through two primary mechanisms. Firstly, the fill material dissipates the kinetic energy of the projectile or blast wave as it travels through the fill material and the ballistics fabric defining the cell walls. Common in-situ fill material is sand, soil, and/or rocks. Secondly, the unique horizontally-offset cellular arrangement of the barrier provides walls that function as shear absorbing boundaries as they are acted upon by the advancing blast waves, scatters the blast waves, and provides a medium through which reflected waves may travel and dissipate. As will be discussed below, the ability to dissipate the blast waves by way of attenuation and scattering is of paramount concern in ballistics barriers.

When a projectile and/or a blast wave from an explosion strikes the barrier, pressure waves are created that travel through the barrier (from the front to the back relative to the projectile's initial engagement with the barrier). The blast or pressure waves are attenuated by the fill material. However, the fill material transmits a portion of the forces created by the pressure waves to the fabric interface, e.g. the ballistics fabric, between the cells. The fabric interface both dissipates and scatters/redirects the pressure wave. The ballistics fabric material (such as TYPAR) dissipates the pressure wave because the ballistics fabric is a shear-absorbing material. Thus, as the pressure waves encounter the cell walls, a significant portion of pressure wave energy is absorbed by the ballistics fabric. Further, as a result of the unique cellular structure and arrangement of the barrier, the cell walls also serve to interrupt and redirect the pressure waves as they travel through the barrier. In sum, the barrier, via the arrangement and composition of the cells, both absorbs and redirects incident pressure waves (this is in addition to the attenuating effects of the fill material in the cells). In the case of a projectile striking the barrier, the present invention encourages the projectile to fragment (by the projectile's interaction with the fill material). This fragmentation serves to dissipate the penetrating capabilities of the projectile.

If a residual pressure wave reaches the fabric at the back of the last filled cell or row of cells, there will be no relatively dense fill material on the other side of the interface for the blast wave to travel through. When this occurs, the pressure wave impacts and distorts/deforms the fabric itself. To effectively manage this situation, the fabric must have sufficient tensile strength to absorb this force and reflect it back in the opposite direction as a tensile stress wave. If the cellular structure were not there to accept and reflect the forces, then the energy carried by the pressure wave would completely dissipate when it encountered the back of the barrier. This dissipation is manifested in the form of a dynamic energy release. Such an energy release can be very destructive. The spalling of the back side of a concrete wall as a result of an impact to the front side is one such manifestation of this type of destructive energy release. However, merely reflecting the tensile stress wave does not alleviate the problem. There must also be a conduit through which the tensile stress wave can travel back through the barrier. In most applications, the fill material will not readily accept the tensile wave. Advantageously, the ballistics fabric defining the cells will readily accept the tensile wave and allow the wave to travel back through the barrier and further dissipate.

Consequently, it is desired to have a barrier to accept, reflect, and dissipate the forces generated from an explosion or ballistics assault. The ballistics fabric serves this role. Thus, the barrier dissipates the kinetic energy of the projectile and/or explosion and provides a medium through which blast waves may travel, and hence dissipate. In this way, the ballistics fabric-based barrier effectively suppresses the damage caused from a ballistics assault or explosion.

Even with such a resilient and robust barrier, as the one described above, it is inevitable that the barrier will be damaged and in need of repair/reconstruction. It is this endeavor at which the present invention is aimed. Because of the reasons cited in the preceding text, it is crucial that any repair efforts maintain the horizontally-offset cell orientation of the ballistics fabric-based barrier.

The method of repair of the present invention includes the following steps: (1) remove the damaged section of the barrier; (2) procure a replacement section of ballistics fabric; and (3) attach the replacement section to the barrier.

More specifically, after the damaged section has been identified, it can be removed in many ways but the construction of the barrier, i.e. ballistics fabric, lends itself to removal by shearing. Removing the damaged section(s) by cutting or shearing can be completed without an arduous undertaking or any specialized tools. Importantly, due to the inherent dangers of working in a conflict setting, removal of the damaged section(s) in this manner can be done quickly.

Once the damaged section has been cleared, a replacement section may be attached to the barrier. Preferably, the replacement section is a length of ballistics fabric. The replacement section is attached to the barrier so that the replacement section forms one or more one horizontally-offset cells, relative to the barrier. Importantly, this allows the replacement section to mimic the structure of the rest of the barrier and continue to provide effective ballistics protection. The replacement section may be sewn, adhered, clipped, stapled, and/or riveted to the barrier (with the latter being the desired attachment technique). In addition to being quick and simple, this attachment procedure maintains the structural integrity of the barrier.

Accordingly, it is an object of the present invention to provide a method for quickly repairing a ballistics barrier.

It is another object of the present invention to provide a method for repairing a ballistics barrier without the need for extensive tooling.

Still another object of the present invention is a method of repairing a ballistics barrier that maintains the protective attributes of the barrier.

It is a final object of the present invention to provide a method of repairing a ballistics barrier that is economical.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operations of the invention.

### BRIEF DESCRIPTION OF THE DRAWINGS

FIG. 1 is an exploded perspective view of a ballistics barrier showing an upper and lower layer with a skirt attached to the lower layer.

FIG. 2 is a perspective view of a ballistics barrier and a yet to be attached replacement section.

FIGS. 3a-d show the steps of repairing a damaged ballistics barrier.

FIGS. 4a-d detail the process of forming a ballistics barrier from multiple sheets of ballistics fabric.

FIG. 5 is an end view of the five vertically-oriented ballistics fabric sheets used to fabricate a barrier of FIG. 4d showing the height difference between the internal and external sheets.

FIG. 6 is an exploded perspective view of a replacement section having two layers with a skirt joining the layers.

FIG. 7 is a side view of a rivet.

### DETAILED DESCRIPTION OF THE PREFERRED EMBODIMENTS

Ballistics barriers are used extensively throughout any military conflict. These barriers may serve as a temporary refuge from enemy fire or as a quasi-permanent shelter from which conflict participants may direct the military campaign. Irrespective of the use, the barriers must be scalable; effective; easy to store, transport and erect; economical to manufacture; and versatile.

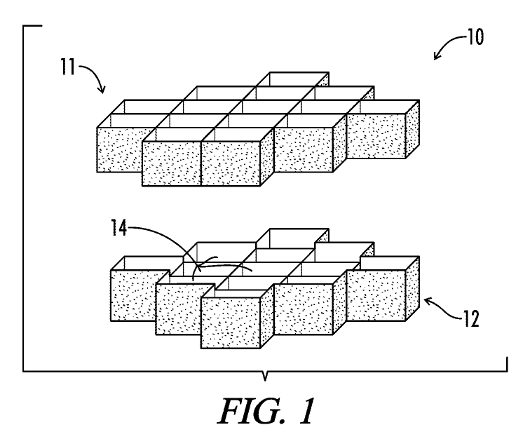

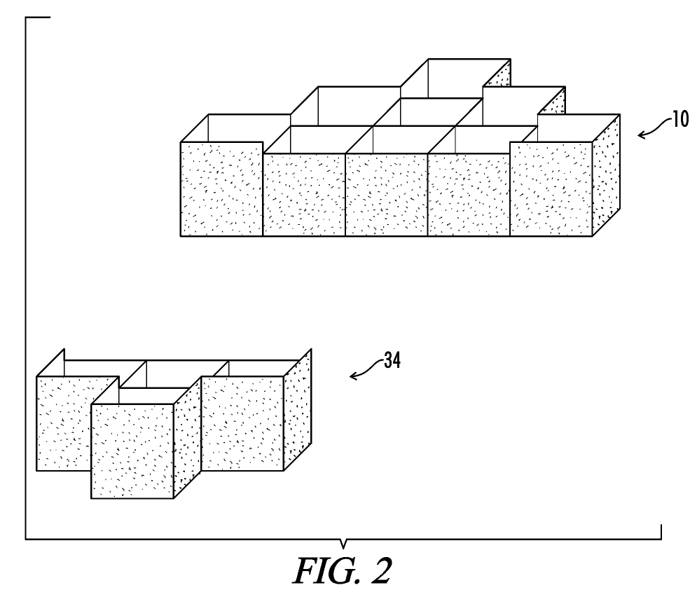

However, a ballistics barrier that satisfied these ends must also be easy to repair or its usefulness and applicability will be severely restricted. The present invention provides a method to repair a ballistics barrier. Particularly, the present invention provides a method to repair a ballistics barrier formed from multiple sheets of ballistics fabric. Prior to discussing the method of the present invention, it will be helpful to first describe a ballistics fabric-based barrier. Such a ballistics barrier 10 or rapid deployment wall 10 is shown in FIG. 1. Ballistics barrier 10 has a layer 12, also referred to as an array 12 or a ballistics fabric matrix 12. The barrier 10 may also have a second layer 11. Layer 12 is comprised of a plurality of horizontally-offset, interconnected cells 14. Second layer 11 may have a similar construction. The cells 14 may be formed by the arrangement and attachment of multiple sheets of ballistics fabric.

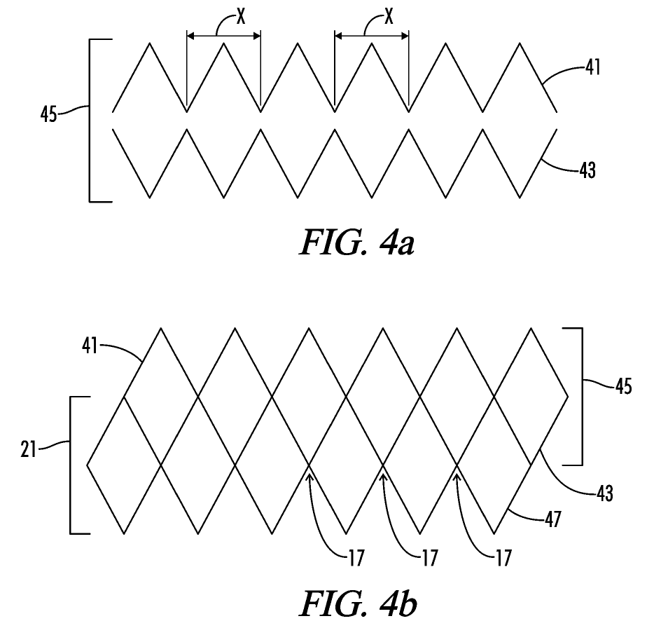

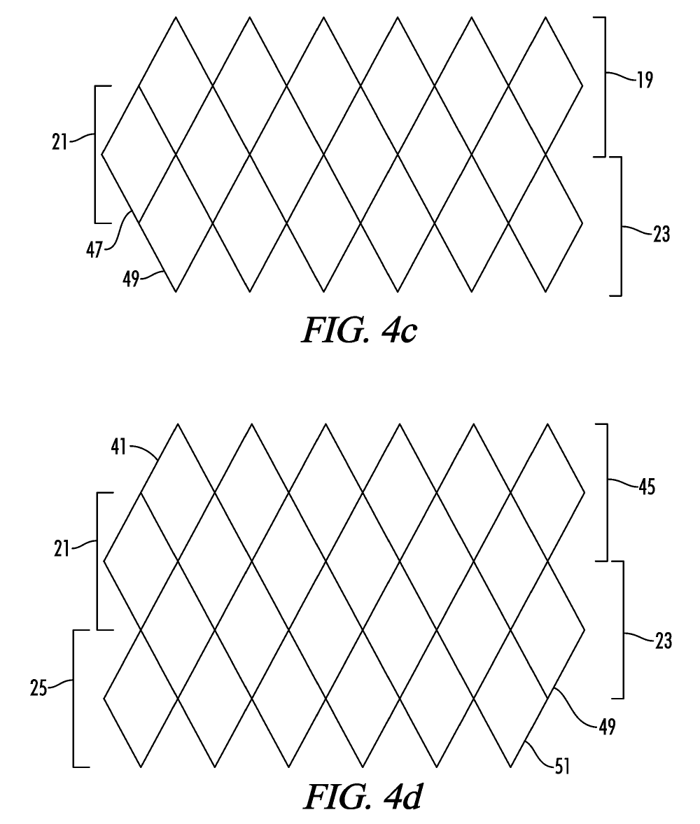

Specifically, the cells 14, and the barrier 10 more generally, may be formed by the exaggerated fabrication sequence illustrated in FIGS. 4a-4d. FIG. 4a shows two pieces of ballistics fabric 41 and 43 being sewn together at interval X to create a row of cells 45. Next, as shown in FIG. 4b, another sheet of fabric 47 is sewn to the first row of cells 45 at locations corresponding to the first rows' vertices 17 (presupposing the first row has assumed a diamond shape) to create a horizontally offset, relative to the first row, second row of cells 21. FIG. 4c shows a fourth sheet of fabric 49 sewn to the third sheet 47 to create yet another row of offset cells 23. Finally, in FIG. 4d a fifth sheet 51 is sewn to the third row of cells (the fourth sheet 49) to create a fourth row of cells 25. The arrangement depicted in FIG. 4d is referred to as a T-2 configuration because an object (such as a projectile) would have to traverse at least two cells regardless of where on the face of the barrier it strikes. For ease of implementation, the actual manufacturing process is affected with the sheets of ballistics fabric oriented in a substantially parallel relationship, i.e. not distended into any particular shape—like the diamond shape of FIGS. 4a-d.

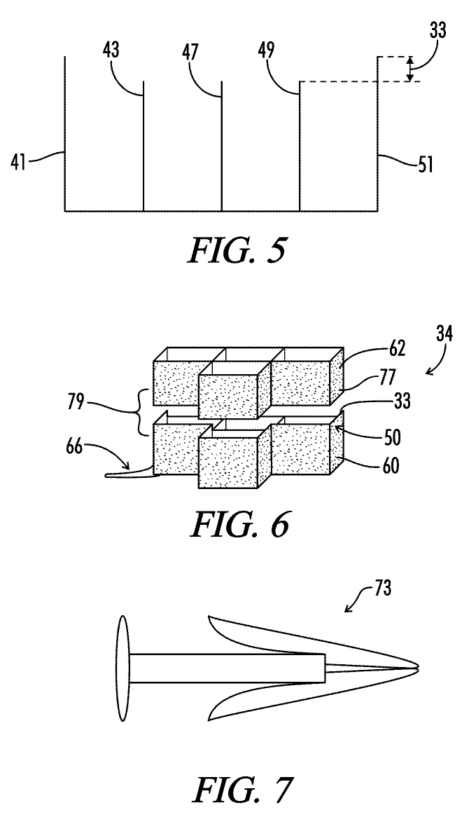

Preferably, the exterior sheets 41 and 51 would have a height greater than the interior sheets 43, 47, and 49. This relationship is clearly presented in FIG. 5. In one preferred embodiment, the exterior sheets 41 and 51 have a height of twenty-four inches while the interior sheets 43, 47, and 49 have a height of twenty inches. After assembly, this height difference provides a skirt 33 or connecting member 33 around the perimeter of the layer.

Desirably, a ballistics fabric comprises the cell walls, and more generally layer 12 in its entirety, and occupies a vital role in the performance of the present invention. The ballistics fabric may be a woven, knitted, or non-woven fibrous web. The ballistics fabric may be a polypropylene-based non-woven geotextile material. In some embodiments, the geotextile comprises about 60% to about 80% polypropylene and about 20% to about 40% polyethylene. However, in the preferred embodiment, the geotextile is comprised entirely from polypropylene (exclusive of impurities).

One such geotextile material is TYPAR®, available from Fiberweb Inc. of Old Hickory, Tenn. TYPAR is a high strength non-woven fabric manufactured using highly oriented individual polyolefin fibers. Desirably, these fibers are between about three and thirty Denier (a unit of weight indicating the fineness of fiber filaments) and even more desirably between about eight and twenty-two Denier. This composition would imbue the geotextile with resistance to naturally occurring soil alkalis and acids (of great import if the fill material is soil). Additionally, the geotextile would be unaffected by bacteria or fungi. Because, in most applications, the geotextile will be exposed to sunlight, and its harmful ultraviolet (UV) radiation, the geotextile may be made from fibers that contain ultraviolet and anti-oxidant additives or be coated with an UV resistant coating to improve the life of the material. As it is often desirable for a ballistics barrier to be camouflaged, the geotextile is receptive to pigmentation, coloring, and dyeing. Thus, the barrier may be camouflaged to reduce its visual footprint. The camouflaged pattern may be matched to the environment in which the barrier will be deployed.

Advantageously, cells constructed in the above-described manner are laterally collapsible. Consider that the cells are formed from a non-rigid fabric and the formation of the cells is only a consequence of the bonding of sheets of fabric together at certain points. Because the fabric is pliable and no rigid framework supports the layer 12, the layer 12 may be collapsed. After the layer 12 has been laterally collapsed, it may also be manipulated into a different form-factor, e.g. the layer 12 may be rolled or folded into a form-factor more amenable to transportation or storage, often referred to as a low logistical footprint. In one preferred embodiment, the barrier 10 has a volume ratio, the ratio of an erected, filled barrier to that of a collapsed and packaged barrier, from about 40:1 to 100:1, with the preferred ratios ranging from approximately 70:1 to 100:1.

Now that a preferred ballistics barrier 10 has been described, the method of the invention can be presented. As discussed previously, an essential characteristic of an effective ballistics barrier is its receptivity to repair efforts. A repair that involves significant amounts of time, material, and/or tooling is undesirable. The present invention provides a method to repair a ballistics barrier that can be carried out with minimal effort and material while maintaining the structural integrity and continuity of the barrier (crucial to preserve the barrier's ballistic dissipating properties).

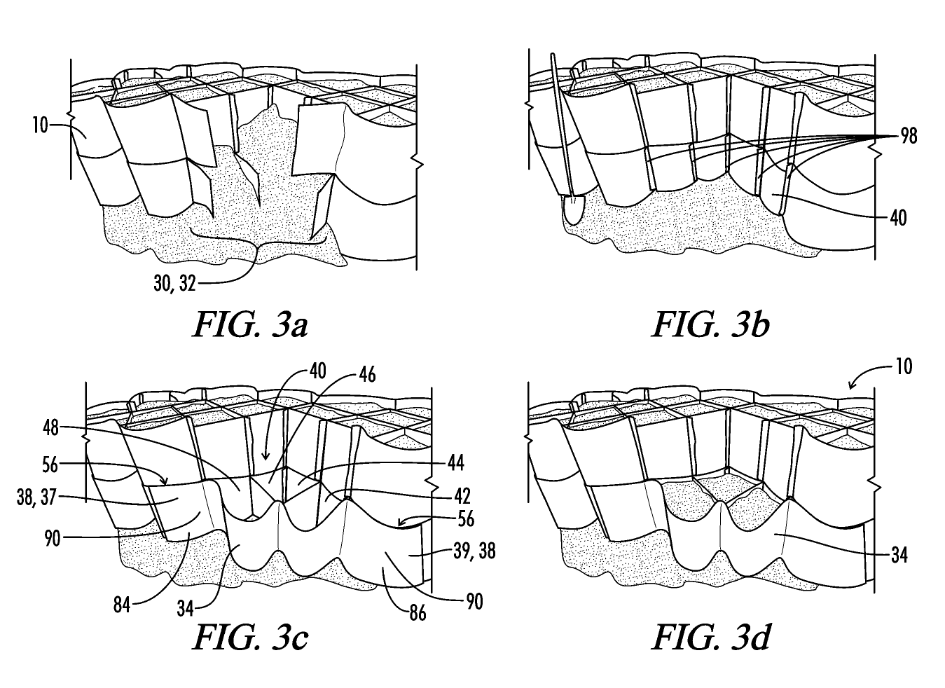

FIG. 3a shows a barrier 10 having sustained damage at a first location 30 or impact zone 30. Initially, the damaged portion 32, or compromised section 32, must be removed. Because the barrier 10 is comprised of ballistics fabric, the damaged section 32 can be removed in a multitude of ways, such as cutting/shearing with a cutting tool or merely a knife. As the barrier 10 is a collection of interconnected cells, it is advisable to leave a small flap 98 (as shown in FIG. 3b) between the damaged portion 32, which is being removed, and the intact cells of the barrier 10. This will help to ensure that the bonding surfaces between the intact cells are not compromised by the repair process.

Depending on the extent and type of damage to the barrier 10, it may be advantageous to first remove the fill material prior to separating the damaged section 32 from the barrier 10. However, regardless of when the fill material is evacuated from the area proximate the first location 30, it is desirable to have an unobstructed stage on which to begin the repairs, as shown in FIG. 3b.

Preferably, a replacement section 34 or assembly 34 is provided that is fabricated from a ballistics fabric similar to that of the barrier 10. In one preferred embodiment the barrier 10 and the replacement section 34 are made from geotextile material. In many applications, it is desirable to have a replacement section 34 with dimensions corresponding to the size/shape (“damaged section dimensions”) of the damaged section 32. This strategy permits the barrier 10 to be restored to its original size/shape, prior to the damage imparted by the projectile/blast wave. Furthermore, the usual situation suggests that the replacement section 34 will be attached to the barrier 10 at or proximate the first location 30. However, it is also envisioned by the present invention that the replacement section 34 has a footprint differing in size or shape from the damaged section 32. For instance, if the first location 30 will be the subject of repeated assaults, the replacement section 34 may exceed the size of the damaged section 32 to bolster the barrier's protective capabilities on that front.

Regardless of the size, shape, or location of the replacement section 34, the salient feature of the section 34 is that it possesses, and is situated relative to the barrier 10 to maintain, the same horizontally-offset cellular structure of the barrier 10. This arrangement permits the replacement section 34 to act in concert with the rest of the barrier 10 to dissipate an impinging projectile or blast wave's energy. The replacement section 34 may be extracted from an existing spare barrier or it may be formed on site from one or more sheets of ballistics fabric through the process described above.

Preferably, the replacement section 34 (containing three cells as depicted in FIG. 3c) has bonding flaps 38 (also referred to as first and second bonding members 37 and 39). The flaps 38 are coupled to the engagement section 90 of the replacement section 34 and extend out beyond and away from the body of the replacement section 34. The flaps 38 overlap and engage to the securement section of the barrier 56. The flaps 38 function to provide an interface to mate the section 34 to the barrier 10. Alternatively described, the replacement section 34 has a first end 84, a second end 86, a first bonding member 37 projecting away from the first end 84, and a second bonding member 39 projecting away from the second end 86. The bonding members 37 and 39 overlap a portion of the undamaged barrier so that once the section 34 has been positioned the members 37 and 39 can be attached to the barrier 10, preferably at the securement section 56, to provide a strong engagement between the section 34 and the barrier 10. Moreover, in an alternative embodiment, the flaps 38 may be integral to the securement section 56 and overlap and couple to the replacement section 34.

In addition to the connective measures offered by the flaps 38, the replacement section 34 may also be coupled to the interior surface of the intact cells 40. Although the section 34 may be attached to the interior surface of the intact cells 40, and the barrier 10 generally, in numerous ways, e.g. sewing, adhesives, staples, the preferred method is with rivets 73, as illustrated in FIG. 7. Typically, a plurality of rivets 73 will be employed to connect the replacement section 34 to the barrier 10 at the first location 30 (or another position if necessary). In one preferred embodiment, depicted in FIG. 3c, cell walls 42, 44, 46, 48 and flaps 38 each have at least two rivets 73 coupling the section 34 to the barrier 10, although, the invention envisions using more or less rivets, or mechanical fasteners, as circumstances dictate. Finally, the replacement section 34 may be packed with fill material as shown in FIG. 3d.

The rivets 73 described in the above repair process may be installed by simply using a punching tool to punch a small hole in the barrier 10 and the replacement section 34, at the rivet's desired location, and inserting the rivet through the hole, alternately, and preferably the use of a rivet with a sharp point and a relatively rigid shaft can be hammered into place without a pilot hole. The punched hole should be sized to require the rivet to be forced into position. This forced fit helps to maximize the strength of the repair. The rivet(s) 73 may be made of plastic, metal, or composite materials. Thus, attaching replacement section 34 to the barrier 10 can be affected with only a handheld punching tool and rivets 73. Such a technique is appreciably faster than many traditional methods, e.g. sewing. Completing quick repairs in a combat setting is of great import in protecting persons and objects seeking shelter behind the barrier 10.

The replacement section 34 may also have a perimeter portion 50 with a skirt 33, as depicted in FIG. 6. The skirt 33 may be integral to the section 34 or the skirt 33 may be a separate component. The skirt 33 serves to prevent fill material from escaping from the top of the section 34. Additionally, if several layers are vertically stacked, the skirt 33 prevents fill material from escaping from the intersection between the layers. Such an embodiment is shown in FIG. 6. In this embodiment replacement section 34 comprises a first layer 60 at a first elevation and a second layer 62 at a second elevation, higher than the first elevation. Layer 62 is positioned on top of and engages layer 60. Once layers 60 and 62 are engaged, e.g. stacked, the skirt 33, if integral to one of the layers 60 or 62, will form a seal between the layers' interface as the skirt 33 will overlap the bottom portion 77 of layer 62. By forming a seal the skirt 33 will prevent fill material from escaping from the interface after layer 62 has been packed. This is especially necessary if the fill material is a fine particulate such as sand. In this multi-layered configuration, the skirt 33 may be integral to the upper layer 62, the bottom layer 60, or a distinct feature. If desired, assuming the layers have been stacked, the portion of the skirt 33 overlapping the bottom 77 of layer 62 may be sewn, adhered, stapled, riveted, or otherwise bonded to layer 62. If the skirt 33 is not integral to either layer 60 or 62 then after the layers 60 and 62 have been positioned the skirt 33 can be attached across the layer-to-layer junction 79. In the preferred embodiment, the skirt 33, if not an integral component, is formed from a geotextile material.

The replacement section 34 may also have a stabilization flange 66 connected to the bottom perimeter of layer 60 and extending out away from the layer 60 as shown in FIG. 6. The stabilization flange 66 can be staked, or otherwise affixed to the surrounding terrain, to provide stability to the section 34 and/or barrier 10 against lateral movements or erosion of the fill, such as those caused by winds or other external factors.

All cited patents, patent applications and publications referred to herein are incorporated by reference.

Thus, although there have been described particular embodiments of the present invention of a new and useful method to repair a ballistics barrier, it is not intended that such references be construed as limitations upon the scope of this invention except as set forth in the following claims.

What is claimed is:

1. A method for repairing a ballistics barrier, comprising:
removing a damaged portion of the ballistics barrier from a first location, wherein the ballistics barrier comprises an array having a first plurality of horizontally-offset, interconnected, laterally collapsible cells, and further wherein the plurality of cells comprises ballistics fabric; and
engaging a replacement section to the ballistics barrier proximate the first location, wherein the replacement section comprises ballistics fabric.

2. The method of claim 1 wherein the replacement section comprises a second plurality of horizontally-offset, interconnected, laterally collapsible cells.

3. The method of claim 2 wherein the replacement section further comprises a first end, a second end opposite the first end, a first bonding member, and a second bonding member, wherein the first bonding member is attached to and projects away from the first end and the second bonding member is attached to and projects away from the second end.

4. The method of claim 1 wherein the ballistics fabric comprises a geotextile material.

5. The method of claim 1 wherein the damaged portion is removed from the array by shearing the damaged portion from the array.

6. The method of claim 1, further comprising:
filling the replacement section with ballistics impeding material.

7. The method of claim 1 wherein the replacement section is engaged to the barrier by one or more rivets.

8. A method for reconstructing a ballistics barrier having a compromised section, comprising:
detaching the compromised section from the ballistics barrier, wherein the ballistics barrier comprises a ballistics fabric matrix; and
replacing the compromised section with a replacement ballistics fabric assembly.

9. The method of claim 8 wherein the ballistics fabric matrix is formed from multiple sheets of ballistics fabric.

10. The method of claim 9 wherein the replacement ballistics fabric assembly comprises an engagement section and the ballistics barrier comprises a securement section proximate the engagement section, further comprising:
affixing one or more bonding flaps between the securement section and the engagement section.

11. The method of claim 8 wherein the ballistics fabric matrix and the replacement ballistics fabric assembly each comprise geotextile material.

12. The method of claim 8 wherein the replacement ballistics fabric assembly is attached to the ballistics barrier by one or more mechanical fasteners.

13. The method of claim 8 wherein the replacement ballistics fabric assembly comprises a bottom portion and a stabilization flange extending away from the bottom portion, further comprising:
securing the replacement ballistics fabric assembly by connecting the stabilization flange to a foundation.

14. The method of claim 8 wherein the compromised section is detached by paring the compromised section from the ballistics barrier.

15. A method of fixing a rapid deployment barrier having an impact zone with a damaged section, comprising:
removing the damaged section from the rapid deployment barrier, wherein the damaged section has damaged section dimensions; and
joining a replacement section, having dimensions corresponding to the damaged section dimensions, to the rapid deployment barrier at the impact zone, wherein the replacement section comprises ballistics fabric.

16. The method of claim 15 wherein the rapid deployment barrier comprises a honeycombed array, and further wherein the array comprises a plurality of open cells formed from multiple sheets of ballistics fabric.

17. The method of claim 16 wherein the replacement section is joined to the barrier by a plurality of mechanical fasteners.

18. The method of claim 15, further comprising:
overlapping a plurality of bonding flaps between the replacement section and the barrier.

19. The method of claim 15 wherein the replacement section comprises a first layer at a first elevation and a second layer at a second elevation, higher than the first elevation, engaging the first layer, and wherein each of the first and second layers comprises a perimeter, the method further comprising:
attaching a skirt between the perimeters of the first and second layers.

20. The method of claim 15 wherein the rapid deployment barrier is camouflaged.
